(19) United States
(12) Patent Application Publication
(10) Pub. No.: US 2008/0209630 A1
(43) Pub. Date: Sep. 4, 2008

(54) Patient Repositioning System

(75) Inventors: Richard Kazala, San Antonio, TX (US); Kenneth R. Smith, San Antonio, TX (US); Bruce Phillips, San Antonio, TX (US); Eric Barta, San Antonio, TX (US); Christopher T. Niederkrom, San Antonio, TX (US)

Correspondence Address: FULBRIGHT & JAWORSKI L.L.P., 600 CONGRESS AVENUE, SUITE 2400, AUSTIN, TX, 78701, US

(73) Assignee: KCI LICENSING, INC., San Antonio, TX (US)

(21) Appl. No.: 11/972,364

(22) Filed: Jan. 10, 2008

Related U.S. Application Data
(60) Provisional application No. 60/885,147, filed on Jan. 16, 2007.
(60) Provisional application No. 60/888,404, filed on Feb. 6, 2007.

(51) Int. Cl. A61G 7/14

(52) U.S. Cl. 5/81.1 T

(57) ABSTRACT

A system and method for repositioning a patient. The system comprises a first layer that is liquid impermeable and vapor permeable. The system also comprises a second layer that has a tensile strength that is greater than the first layer. The tensile strength of the second layer is sufficient to allow the system to lift a person being repositioned. The system also comprises a plurality of handles distributed around the sheet.

### CROSS-REFERENCE TO RELATED APPLICATIONS

This application claims the priority of U.S. Provisional Patent Application Ser. No. 60/885,147 filed Jan. 16, 2007 and U.S. Provisional Patent Application Ser. No. 60/888,404 filed Feb. 6, 2007, the entire disclosures of which are specifically incorporated herein by reference.

### FIELD OF THE INVENTION

The present disclosure relates generally to apparatus, methods, and systems used to reposition patients or other persons who need assistance in being repositioned.

### BACKGROUND

Patients and other persons restricted to bed for extended periods often require assistance in being repositioned within a bed or transferred from one bed to another bed or support surface. Depending on the type of repositioning being performed, a caregiver may need to employ a lifting sling, a transfer sheet, a roll sheet, or a repositioning sheet. A lifting sling may be used when a person is being lifted out of bed with an overhead lifting device, while a transfer sheet may be used to transfer a person from one bed to another support surface. A roll sheet may be used to roll a person within a bed, and a repositioning sheet may be used to transversely move a patient towards one end or one side of a bed.

In typical prior art systems, the repositioning device is not left underneath the patient when not in use. The repositioning device may not be left under the patient for a number of reasons. For example, the material from which the repositioning device is constructed may have a high coefficient of friction so that it is not comfortable for the patient and may cause skin breakdown after extended exposure. The repositioning device may also have undesirable air, vapor, or liquid permeability which can lead to skin breakdown. Therefore, the repositioning device is typically removed after use so that it does not remain between the patient and the support surface.

Because repositioning devices are not typically left in place when not in use, it is necessary for a caregiver to locate a suitable device before performing a repositioning maneuver. This may take considerable time on the part of the caregiver because a limited number of repositioning devices are typically kept at a care facility. In addition, depending on the type of repositioning maneuver being performed, a caregiver may have to locate a specific type of repositioning device (e.g., a lifting sling, a transfer sheet, a roll sheet, or a repositioning sheet). It is therefore desirable to reduce the amount of time that a caregiver must spend locating a proper repositioning device.

Furthermore, once the caregiver has located the proper repositioning device, the person being repositioned must be turned, lifted, or otherwise manipulated by the caregiver (or caregivers) so that the repositioning device can be placed underneath the person. Such manipulation of the patient can present ergonomic challenges that may strain the caregiver and increase the risk of injury to the caregiver. Recent initiatives, such as the Handle with Care campaign launched by the American Nurses Association, have led to legislation that limits the amount of a patient's weight that a caregiver may lift. It is therefore desirable to limit the number of times that a patient must be manipulated by caregivers in order to insert a repositioning device underneath the patient.

### SUMMARY

Certain exemplary embodiments of the present disclosure comprise a system and method for repositioning a person.

Specific exemplary embodiments include a sheet comprising a first layer that is liquid impermeable and vapor permeable, and a second layer of material that has a tensile strength that is greater than the tensile strength of the first layer. Certain exemplary embodiments may also include a plurality of handles distributed around the sheet. In specific exemplary embodiments, the second layer has a tensile strength sufficient to allow the sheet to lift a person weighing approximately 350 pounds or greater, while in other exemplary embodiments the second layer that has a tensile strength sufficient to allow the sheet to lift a person weighing approximately 1000 pounds or greater. In certain exemplary embodiments, the second layer comprises a material that has a tensile strength of approximately 4.1 to 5.4 grams/denier.

In certain exemplary embodiments, the first layer comprises polytetrafluoroethylene sheet, while in other exemplary embodiments, the first layer may comprise nylon or a polyester sheet and/or a backing sheet. In specific exemplary embodiments, the second layer comprises a nylon sheet that is 400 or greater denier.

In certain exemplary embodiments, the first layer comprises a material that is air impermeable, and in other exemplary embodiments, the first layer and the second layer are both vapor permeable. In specific exemplary embodiments, the first layer comprises GoreTex or Gore Medical Fabric, and/or the second layer comprises nylon.

Specific exemplary embodiments may comprise a compartment for storing the system, and the compartment may be coupled to the sheet. In exemplary embodiments, the handles comprise multiple straps. In specific exemplary embodiments, the first layer and second layer may be RF welded or sewn at an interface around the perimeter of the sheet. In certain exemplary embodiments, the first layer and second layer may be laminated together, and in specific exemplary embodiments the first layer and the second layer may be laminated around the perimeter of the sheet. In specific exemplary embodiments, a majority of the first layer is laminated to the second layer.

Certain exemplary embodiments may comprise a slit in the sheet that allows a first portion of the sheet to move independently of a second portion of the sheet. In specific exemplary embodiments, the sheet comprises a first side, a second side, a first end and a second end, and the slit is proximal to either the first end or the second end of the sheet.

Certain exemplary embodiments may comprise a system for supporting and repositioning a patient, and the system may include: a frame; a mattress comprising an upper surface; and a multi-layered repositioning system placed on the upper surface. In specific exemplary embodiments, the multi-layered repositioning system may comprise an upper layer that is liquid impermeable and vapor permeable and a lower layer that has a tensile strength that is greater than the tensile strength of the upper layer.

Still other exemplary embodiments may comprise a method of repositioning a patient, the method comprising: providing a support surface and providing a repositioning device on the support surface. In certain exemplary embodiments, the repositioning device may comprise a first layer that is liquid impermeable and vapor permeable, a second layer that has a tensile strength that is greater than the tensile strength of the first layer, and a plurality of handles distributed around the repositioning device. In specific exemplary embodiments, the method may include placing a patient in a first position on the support surface and the repositioning device so that the patient is in contact with the first layer of the repositioning device. The method may also include allowing the patient to remain on the repositioning device for an extended period of time, and manipulating the repositioning device so that the patient is repositioned to a second position. In specific exemplary embodiments, the extended period of time may comprise more than one day. In other exemplary embodiments, the extended period of time may comprise more than two days.

### BRIEF DESCRIPTION OF THE DRAWINGS

While exemplary embodiments of the present invention have been shown and described in detail below, it will be clear to the person skilled in the art that changes and modifications may be made without departing from the scope of the invention. As such, that which is set forth in the following description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention. For example, different materials of construction may be used for the layers employed in the system. Furthermore, the number of layers and the number and location of the handles may also be altered.

In the following Detailed Description of Disclosed Embodiments, various features are grouped together in several embodiments for the purpose of streamlining the disclosure. This method of disclosure is not to be interpreted as reflecting an intention that exemplary embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

FIG. 1 illustrates a top view of a first exemplary embodiment of a patient repositioning system;

FIG. 2 illustrates an end view of the embodiment of FIG. 1;

FIG. 3 illustrates a side view of a second exemplary embodiment of a patient repositioning system;

FIG. 4 illustrates a partial cross-sectional side view of the embodiment of FIG. 1;

FIG. 5 illustrates a partial cross-sectional side view of the embodiment of FIG. 1;

FIG. 6 illustrates a partial cross-sectional side view of a second embodiment of a patient repositioning system;

FIG. 7 illustrates a top view of a third embodiment of a patient repositioning system; and

FIG. 8 illustrates an end view of the embodiment of FIG. 7.

### DETAILED DESCRIPTION OF DISCLOSED EMBODIMENTS

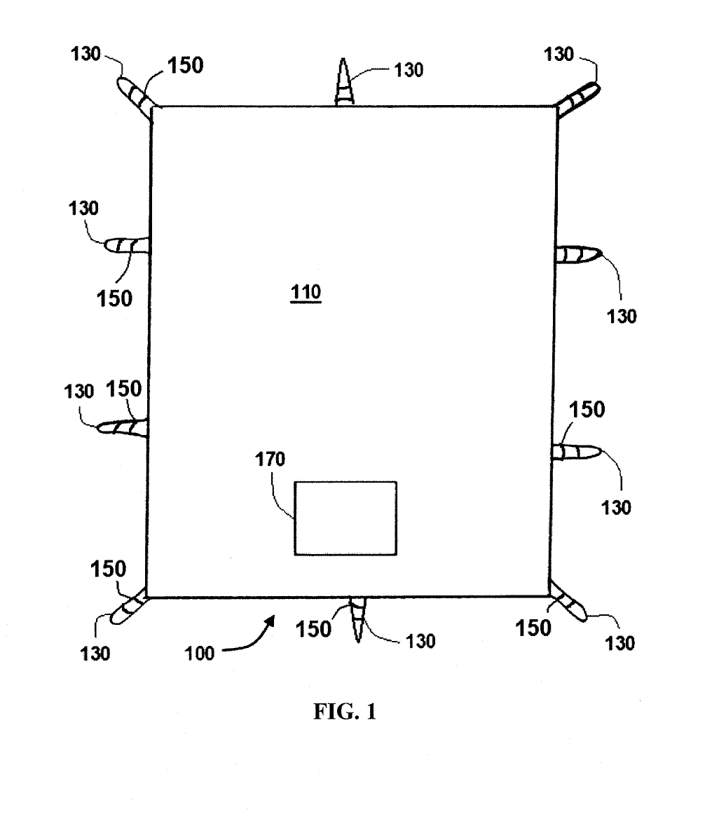

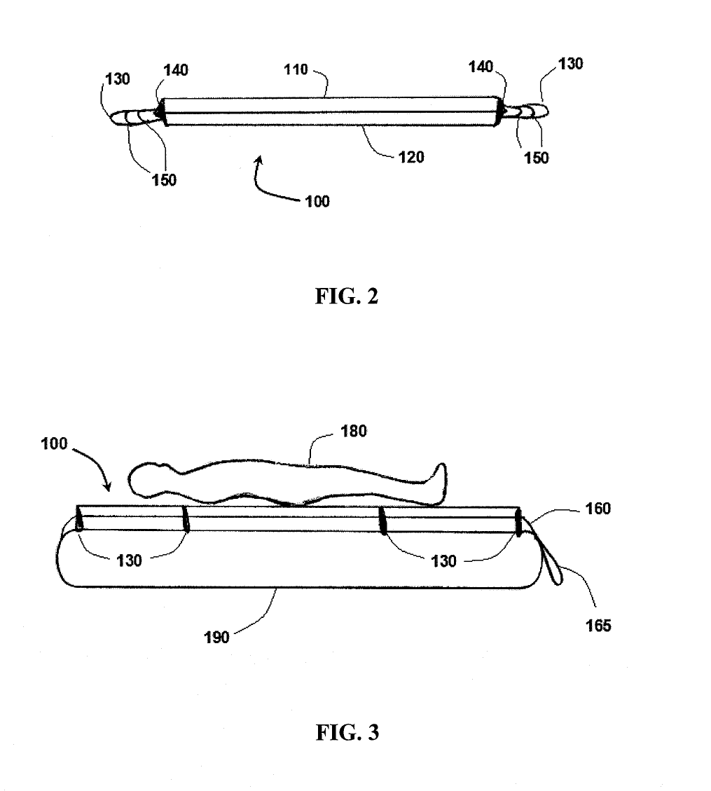

Referring initially to FIGS. 1 and 2, one embodiment of a patient repositioning system (PRS) 100 comprises a first layer 110 and a second layer 120. The disclosed embodiment further comprises a plurality of handles 130 distributed around the perimeter of PRS 100, as well as an interface 140 between first layer 110 and second layer 120. In the embodiment shown, PRS 100 also comprises written indicia 170.

In certain embodiments, first layer 110 and second layer 120 may be RF welded or ultrasonically welded at interface 140. In other embodiments, first layer 110 and second layer 120 may be sewn together at interface 140. In the embodiment shown, four separate handles 130 are distributed at each side along the length of PRS 100. In other embodiments, handles 130 may be coupled to PRS 100 at other locations; for example handles 130 may be placed at the end of PRS 100.

First layer 110 and second layer 120 may be comprised of various types of materials. In the embodiment shown, first layer 110 is comprised of a material that is liquid impermeable, and vapor permeable. First layer 110 may comprise a material that is either air permeable or air impermeable. One example of such an air impermeable material is sold under the trade name Gore-Tex® or Gore Medical Fabric. In certain applications, Gore-Tex® or Gore Medical Fabric is comprised of a polytetrafluoroethylene (PTFE) sheet laminated to a surface fabric, e.g. nylon or polyester. In the embodiment shown, second layer 120 is comprised of a material that has a tensile strength and a shear strength greater than first layer 110. Examples of such materials include 400 (or greater) denier nylon. In certain embodiments, second layer 120 has a tensile strength and shear strength sufficient to support a person weighing greater than approximately 350 pounds. In other embodiments, second layer 120 has a tensile strength and shear strength sufficient to support a person weighing up to approximately 1,000 pounds. In specific exemplary embodiments, second layer 120 comprises a material that has a tensile strength of approximately 4.1 to 5.4 grams/denier.

Referring now to FIG. 3, PRS 100 may be placed on top of a cover sheet 160 and a mattress 190 or other patient support system. Mattress 190 may be of any suitable configuration, including products that assist in removing moisture vapor from the surface a person 180 supported by mattress 190. Example of such mattresses include products sold under the trade names MaxxAir ETS®, BariAir®, AtmosAir® and First Step Select® Heavy Duty. Cover sheet 160 may also comprise a compartment 165 for storing PRS 100 when PRS 100 is not in use. It is desirable that PRS 100 does not significantly reduce the moisture vapor transfer rate provided by mattress 190. Therefore, first layer 110 and second layer 120 should both be vapor permeable. It is also desirable that first layer 110 is liquid impermeable to prevent liquids from penetrating first layer 110 and possibly contaminating second layer 120 or supporting materials below PRS 100. Liquid impermeability of first layer 110 may reduce the need to clean or sterilize components below first layer 110.

In addition, it is desired that PRS 100 have sufficient strength to allow a nurse or other caregiver to re-position person 180. Furthermore, it is desired that first layer 110 does not significantly increase the interface pressure between person 180 and mattress 190. Still further, it is desired that the coefficient of friction between first layer 110 and person 180 is low enough to provide a comfortable surface for person 180 to lay upon for extended periods of time. It is also desired that the coefficient of friction between second layer 120 and mattress 190 is low enough to allow a caregiver to reposition person 180.

PRS 100 provides numerous advantages over existing devices used to reposition patients. For example, PRS 100 can remain between person 180 and mattress 190 for extended periods of time without significantly affecting the moisture vapor transfer rate, the interface pressure, or the friction forces between person 180 and supporting materials. Therefore, it is not necessary to insert PRS 100 between person 180 and mattress 190 each time person 180 must be repositioned. By allowing PRS 100 to remain in place between person 180 and mattress 190, the process of repositioning person 180 is simplified when compared to typical prior methods.

In typical prior methods of repositioning a person, a caregiver must first locate a device suitable for repositioning the person. Because prior repositioning devices were not left in place between the person and the mattress (or other support system), a caregiver could spend considerable time attempting to locate a suitable repositioning device. Depending on the type of repositioning being performed, a caregiver may have to locate a lifting sling, a transfer sheet, a roll sheet, or a repositioning sheet.

By employing PRS 100, the amount of time required to reposition person 180 may be significantly reduced. For example, a caregiver will not have to spend time locating a repositioning device because PRS 100 may be left in place between person 180 and mattress 190. In certain embodiments, PRS 100 may perform the functions of a lifting sling, a transfer sheet, a roll sheet, and a repositioning sheet. Therefore, a caregiver may perform numerous different functions without having to locate a specific device for a repositioning task.

Furthermore, PRS 100 also reduces the amount of time required to reposition person 180 because PRS 100 does not have to be initially placed between person 180 and mattress 190. By leaving PRS 100 in place between person 180 and mattress 190, a caregiver does not have to initially move person 180 and place PRS 100 underneath him or her.

In addition to reducing the amount of time required to reposition person 180, PRS 100 can also reduce the likelihood that a caregiver will be injured during the repositioning process. By leaving PRS 100 in place, a caregiver does not have to exert force to roll or lift person 180 and insert PRS 100 underneath person 180. Because person 180 does not have to be rolled or otherwise moved in order to position PRS 100, it may be possible to reposition person 180 with fewer caregivers than would otherwise be possible. For example, if person 180 is a bariatric patient, it may take several caregivers to move person 180 in order to position PRS 100. Eliminating the need to move person 180 for placement of PRS 100 may also reduce the likelihood that person 180 will be injured.

During a repositioning of person 180, a caregiver (or multiple caregivers) may grasp a handle or handles 130 and pull PRS 100 in a direction of desired movement. For example, if PRS 100 is being used to reposition person 180 onto a different area of mattress 190, a caregiver or caregivers could pull on handles 180 towards the desired location. If PRS 100 is being used to roll person 180, a caregiver or caregivers could lift up on handle or handles 130 on one side of PRS 100. If PRS 100 is being used to transfer person 180 from mattress 190 to another support surface, then multiple caregivers may lift up on handles 130 on opposite sides of PRS 100 to pick up person 180 and transfer him or her to a different support surface. If PRS 100 is being used as a sling, handles 130 may be attached to an appropriate lifting device to raise person 180.

Handles 130 may be coupled to first layer 110 and/or second layer 120 via any suitable manner (e.g., sewing or other mechanical attachment methods). Handles 130 may also be integral to second layer 120 and/or first layer 110. In the embodiment shown, handles 130 comprise intermediate straps 150 that may be employed when using PRS 100 as a sling. Intermediate straps 150 provide multiple locations for connecting a lifting device to PRS 100, thereby providing added flexibility in the positioning of person 180 when connecting external lifting or moving devices to PRS 100.

In the embodiment shown in FIG. 1, PRS 100 comprises written indicia 170. Written indicia 170 may comprise instructions for use or cleaning of PRS 100. Written indicia 170 may also comprise design limitations of PRS 100; for example, written indicia 170 may provide the maximum weight of a person that may be repositioned or lifted via PRS 100.

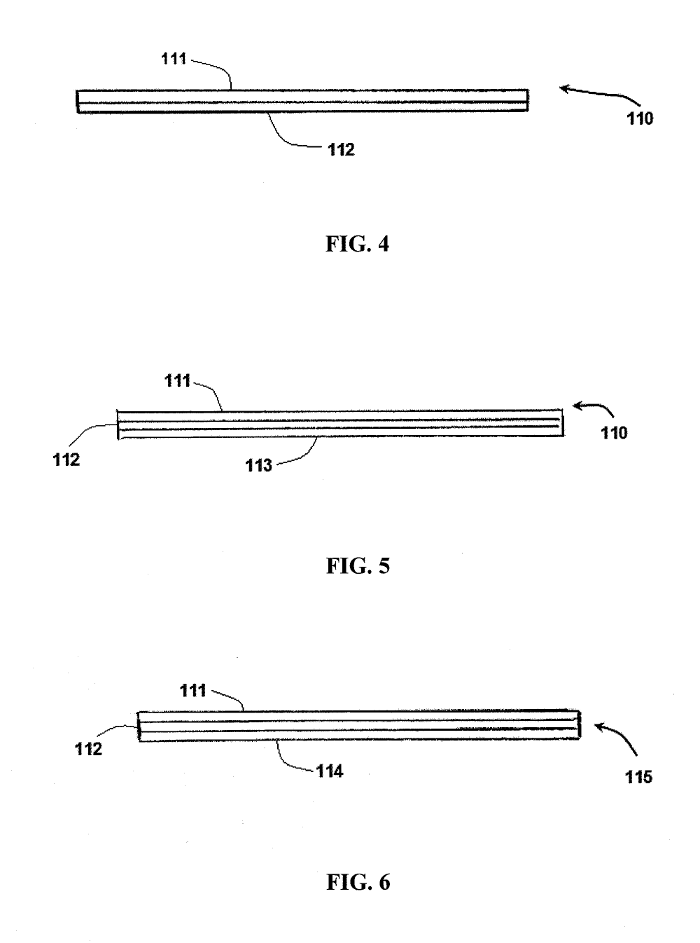

Embodiments of PRS 100 may comprise various materials for first layer 110 and second layer 120. FIGS. 4 and 5 represent partial side section views of different configurations for layer 110. In the embodiment shown in FIG. 4, for example, first layer 110 may be comprised of a low friction material 111 (e.g., nylon or polyester) on the side that contacts person 180 and a PTFE material 112 on the opposite side. In the embodiment shown in FIG. 5, first layer 110 may also comprise low friction material 111 on the side that contacts person 180, a PTFE material 112 in the intermediate position, and a backing layer 113 that may be comprised of knit polyester or other suitable protective material. The backing layer 113 may protect the PTFE material 112 from abrasions during laundering or other processes that could damage the PTFE.

In the embodiment shown in FIG. 6, layers equivalent to first layer 110 and second layer 120 of previous embodiments may be coupled or laminated together to form a combination layer 115. In the embodiment shown, combination layer 115 comprises low friction material 111 on the side that contacts person 180, a middle layer of PTFE material 112, and a backing of a high-strength material 114 (e.g., a 400 or greater denier nylon). In such an embodiment, combination layer 115 comprises low friction characteristics for patient comfort, as well as vapor permeability, liquid impermeability, and sufficient strength to reposition a person when necessary.

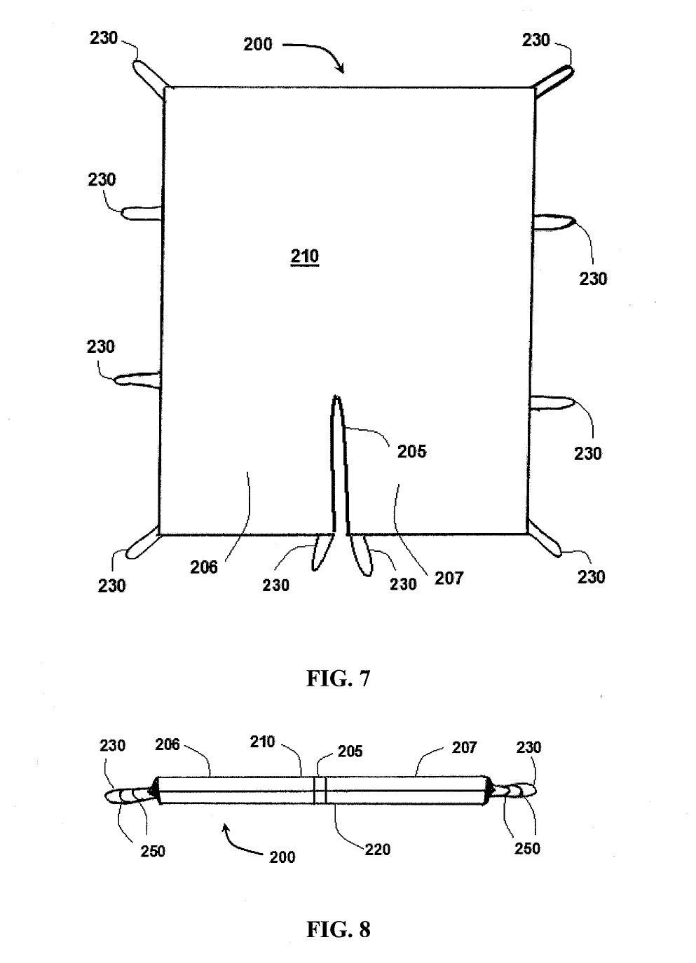

In the embodiment shown in FIGS. 7 and 8, a PRS 200 comprises a first layer 210 and second layer 220, which are equivalent to first layer 110 and second layer 120 of previously-described embodiments. PRS 200 also comprises a split 205 that allows a first portion 206 of PRS 200 to be moved while a second portion 207 of PRS 200 remains stationary. The embodiment shown in FIG. 7 therefore permits individual body parts (such as a single leg or arm) to be moved without moving an entire person (not shown). PRS 200 may also comprise a plurality of handles 230 similar to those of previously-described embodiments. In the embodiment shown, PRS 200 comprises additional handles 230 on portions 206 and 207 to allow for individual lifting of portions 206 and 207.

1. A system for repositioning a person, the system comprising:
a sheet comprising:
a first layer that is liquid impermeable and vapor permeable;
a second layer of material that has a tensile strength that is greater than the tensile strength of the first layer; and
a plurality of handles distributed around the sheet.

2. The system of claim 1 wherein the second layer has a tensile strength sufficient to allow the sheet to lift a person weighing approximately 350 pounds or greater.

3. The system of claim 1 wherein the second layer comprises a material that has a tensile strength of approximately 4.1 to 5.4 grams/denier.

4. The system of claim 1 wherein the second layer has a tensile strength sufficient to allow the sheet to lift a person weighing approximately 1000 pounds or greater.

5. The system of claim 1 wherein the first layer comprises a polytetrafluoroethylene sheet.

6. The system of claim 5 wherein the second layer comprises a nylon sheet that is 400 or greater denier.

7. The system of claim 5 wherein the first layer further comprises a nylon or polyester sheet.

8. The system of claim 7 wherein the first layer further comprises a backing sheet.

9. The system of claim 1 wherein the first layer comprises a material that is air impermeable.

10. The system of claim 1 wherein the first layer and the second layer are both vapor permeable.

11. The system of claim 1 wherein the first layer comprises GoreTex or Gore Medical Fabric.

12. The system of claim 1 wherein the second layer comprises nylon.

13. The system of claim 1 further comprising a compartment for storing the system, wherein the compartment is coupled to the sheet.

14. The system of claim 1 wherein the handles comprise multiple straps.

15. The system of claim 1 wherein the first layer and second layer are RF welded at an interface around the perimeter of the sheet.

16. The system of claim 1 wherein the first layer and second layer are sewn together at an interface around the perimeter of the sheet.

17. The system of claim 1 wherein the first layer and second layer are laminated together.

18. The system of claim 1 wherein the first layer and the second layer are laminated around the perimeter of the sheet.

19. The system of claim 1 wherein a majority of the first layer is laminated to the second layer.

20. The system of claim 1 further comprising a slit in the sheet that allows a first portion of the sheet to move independently of a second portion of the sheet.

21. The system of claim 20 wherein:
the sheet comprises a first side, a second side, a first end and a second end; and
the slit is proximal to either the first end or the second end of the sheet.

22. The system of claim 19 wherein the second layer comprises nylon.

23. A system for supporting and repositioning a patient, the system comprising:
a frame;
a mattress comprising an upper surface; and
a multi-layered repositioning system placed on the upper surface, wherein the multi-layered repositioning system comprises:
an upper layer that is liquid impermeable and vapor permeable; and
a lower layer that has a tensile strength that is greater than the tensile strength of the upper layer.

24. A method of repositioning a patient, the method comprising:
providing a support surface;
providing a repositioning device on the support surface, wherein the repositioning device comprises:
a first layer that is liquid impermeable and vapor permeable;
a second layer that has a tensile strength that is greater than the tensile strength of the first layer; and
a plurality of handles distributed around the repositioning device;
placing a patient in a first position on the support surface and the repositioning device so that the patient is in contact with the first layer of the repositioning device;
allowing the patient to remain on the repositioning device for an extended period of time; and
manipulating the repositioning device so that the patient is repositioned to a second position.

25. The method of claim 24 wherein the extended period of time comprises more than one day.
